(19) United States
(12) Patent Application Publication
(10) Pub. No.: US 2018/0152941 A1
(43) Pub. Date: May 31, 2018

(54) METHODS FOR ENHANCING PERFORMANCE OF A COMMUNICATIONS APPARATUS AND COMMUNICATIONS APPARATUS UTILIZING THE SAME

(71) Applicant: MEDIATEK INC., Hsin-Chu (TW)

(72) Inventors: Yi-Ting CHENG, Taipei City (TW); Yen-Ku LIU, New Taipei City (TW)

(21) Appl. No.: 15/365,051

(22) Filed: Nov. 30, 2016

(51) Int. Cl. H04W 72/04; H04W 24/08; H04W 64/00; H04L 5/00

(52) U.S. Cl. CPC H04W 72/0446; H04W 24/08; H04W 88/06; H04L 5/006; H04W 64/006

(57) ABSTRACT

A communications apparatus includes a radio transceiver and a processor. The radio transceiver transmits or receives wireless radio frequency signals to communicate with a first network device. The processor estimates a period for the first network device to transmit a timing advance (TA) command according to a plurality of previously received TA commands, determines an arrival time of a forthcoming TA command according to the estimated period, determines whether to skip a chance to receive the forthcoming TA command at the arrival time according to the estimated period and a TA timer interval, and does not use the radio transceiver to receive the forthcoming TA command at the arrival time when determining to skip the chance to receive the forthcoming TA command.

### BACKGROUND OF THE INVENTION

### Field of the Invention

The invention relates to methods for enhancing performance of a communications apparatus.

### Description of the Related Art

The term “wireless” normally refers to an electrical or electronic operation, which is accomplished without the use of a “hard wired” connection. “Wireless communications” is the transfer of information over a distance without the use of electrical conductors or wires. The distances involved may be short (a few meters for television remote controls) or very long (thousands or even millions of kilometers for radio communications). The best known example of wireless communications is the cellular telephone. Cellular telephones use radio waves to enable an operator to make phone calls to another party from many locations worldwide. They can be used anywhere, as long as there is a cellular telephone site to house equipment that can transmit and receive signals, which are processed to transfer both voice and data to and from the cellular telephones.

There are various well-developed and well-defined cellular communications technologies. For example, the Global System for Mobile communications (GSM) is a well-defined and commonly used communications system, which uses time division multiple access (TDMA) technology, which is a multiplex access scheme for digital radio, to send voice, data, and signaling data (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Wireless Fidelity (Wi-Fi) is a technology defined by the 802.11 engineering standard and can be used for home networks, mobile phones, video games, to provide a high-frequency wireless local area network. The Long-Term Evolution (LTE) is a standard for wireless communication of high-speed data for mobile phones and data terminals. It is based on the GSM/EDGE and UMTS/HSPA network technologies, increasing the capacity and speed using a different radio interface together with core network improvements.

In order to provide more efficient communications services, methods for enhancing performance of a communications apparatus are provided.

### BRIEF SUMMARY OF THE INVENTION

A communications apparatus and methods for enhancing the performance of a communications apparatus are provided. An exemplary embodiment of a communications apparatus comprises a radio transceiver and a processor. The radio transceiver transmits or receives wireless radio frequency signals to communicate with a first network device. The processor estimates a period for the first network device to transmit a timing advance (TA) command according to a plurality of previously received TA commands, determines an arrival time of a forthcoming TA command according to the estimated period, determines whether to skip a chance to receive the forthcoming TA command at the arrival time according to the estimated period and a TA timer interval, and does not use the radio transceiver to receive the forthcoming TA command at the arrival time when determining to skip the chance to receive the forthcoming TA command.

An exemplary embodiment of a method for enhancing performance of a communications apparatus comprises: estimating a period for a first network device to transmit a timing advance (TA) command according to a plurality of previously received TA commands; determining an arrival time of a forthcoming TA command according to the estimated period; determining whether to skip a chance to receive the forthcoming TA command at the arrival time according to the estimated period and a TA timer interval; and not receiving the forthcoming TA command at the arrival time when determining to skip the chance to receive the forthcoming TA command.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A shows an exemplary block diagram of a communications apparatus according to an embodiment of the invention;

FIG. 1B shows an exemplary block diagram of a communications apparatus according to another embodiment of the invention;

FIG. 2 shows an exemplary block diagram of a modem according to an embodiment of the invention;

FIG. 3 shows an exemplary block diagram of a communications apparatus having at least two communications units according to an embodiment of the invention;

FIG. 4 is a flow chart of a method for enhancing performance of a communications apparatus according to an embodiment of the invention; and

FIG. 5 is a flow chart of a method for enhancing performance of a communications apparatus according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

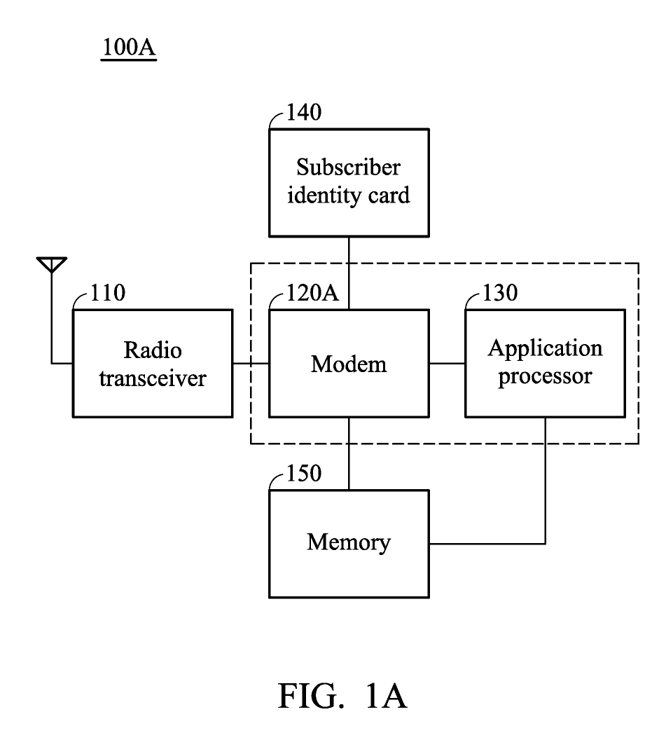

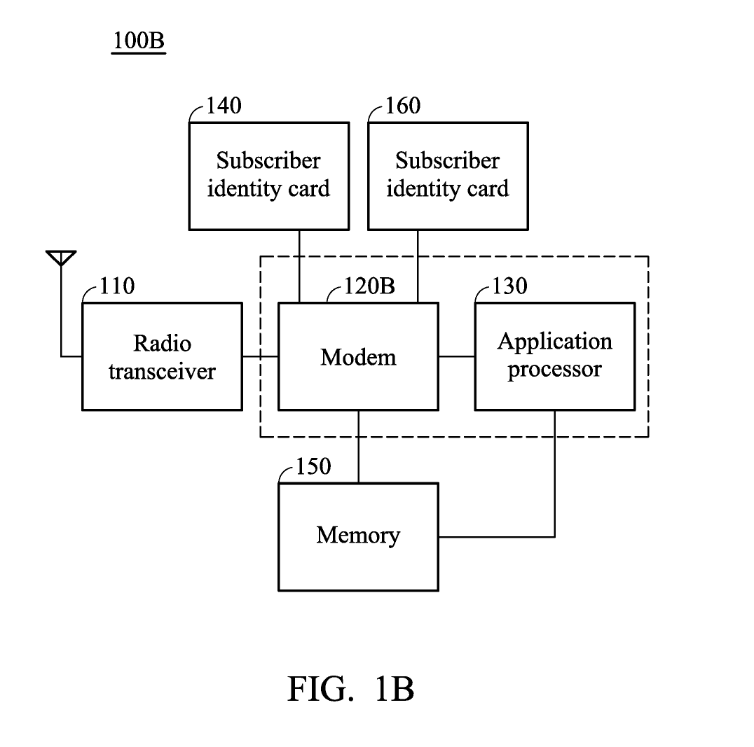

FIG. 1A shows an exemplary block diagram of a communications apparatus according to an embodiment of the invention. The communications apparatus 100A may be a portable electronic device, such as a Mobile Station (MS, which may be interchangeably referred to as User Equipment (UE)). The communications apparatus 100A may comprise at least an antenna module comprising at least one antenna, a radio transceiver 110, a modem 120A, an application processor 130, a subscriber identity card 140, and a memory 150. The radio transceiver 110 may receive wireless radio frequency signals via the antenna module, transmit wireless radio frequency signals via the antenna module and perform RF signal processing. For example, the radio transceiver 110 may convert the received signals into intermediate frequency (IF) or baseband signals to be processed, or receive the IF or baseband signals from the modem 120A and convert the received signals to wireless radio frequency signals to be transmitted to a network device. According to an embodiment of the invention, the network device may be a cell, an evolved node B, a base station, a Mobility Management Entity (MME) etc., at the network side and communicating with the communications apparatus 100A via the wireless radio frequency signals.

The radio transceiver 110 may comprise a plurality of hardware devices to perform radio frequency conversion and RF signal processing. For example, the radio transceiver 110 may comprise a power amplifier for amplifying the RF signals, a filter for filtering unwanted portions of the RF signals and/or a mixer for performing radio frequency conversion. According to an embodiment of the invention, the radio frequency may be, for example, 900 MHz or 1800 MHz for a Global System for Mobile communication (GSM), or 1900 MHz for a Universal Mobile Telecommunications System (UMTS), or the frequency of any specific frequency band for a Long-Term Evolution (LTE) system, etc.

The modem 120A may be a cellular communications modem configured for handling cellular system communications protocol operations and processing the IF or baseband signals received from or to be transmitted to the radio transceiver 110. The application processor 130 is configured for running the operating system of the communications apparatus 100A and running application programs installed in the communications apparatus 100A. In the embodiments of the invention, the modem 120A and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an International Mobile Subscriber Identity (IMSI) and a set of SIM application toolkit (SAT) commands and may provide storage space for phone book contacts. The memory 150 may be coupled to the modem 120A and application processor 130 and may store system data or user data.

FIG. 1A shows a single-card architecture. The single-card single-standby application can be achieved based on the architecture shown in FIG. 1A. In addition, in some embodiments of the invention, a single-card multi-standby application such as a single radio LTE (SRLTE) application, a virtual SIM card application, and so on, can also be achieved based on the architecture shown in FIG. 1A.

In other embodiments of the invention, the communications apparatuses can also support a multi-card multi-standby application and handling multi-RAT (radio access technology) operations, such as at least two of GSM/GPRS/EDGE (Global System for Mobile Communications/General Packet Radio Service/Enhanced Data rates for Global Evolution), WCDMA (Wideband Code Division Multiple Access), cdma2000, WiMAX (Worldwide Interoperability for Microwave Access), TD-SCDMA (Time Division Synchronous Code Division Multiple Access), LTE (Long Term Evolution), and TD-LTE (Time Division Long Term Evolution) RATs, or the like, via one communications apparatus.

FIG. 1B shows an exemplary block diagram of a communications apparatus according to another embodiment of the invention. Most of the elements shown in FIG. 1B are similar to FIG. 1A, and thus the descriptions are omitted here for brevity. In this embodiment, the communications apparatus 100B may comprise multiple subscriber identity cards 140 and 160 coupled to the modem 120B, thereby the modem 120B may at least support two RATs communications, wherein the two RATs may be different RATs or the same RAT, and the invention should not be limited to either case.

Note that in the embodiments of the invention, the subscriber identity card 140 or 160 may be a dedicated hardware card (e.g., a real SIM, USIM, R-UIM or CSIM card), or a virtual card (e.g., a virtual SIM, USIM, R-UIM or CSIM card). Therefore, the invention is not limited to any specific implementation method.

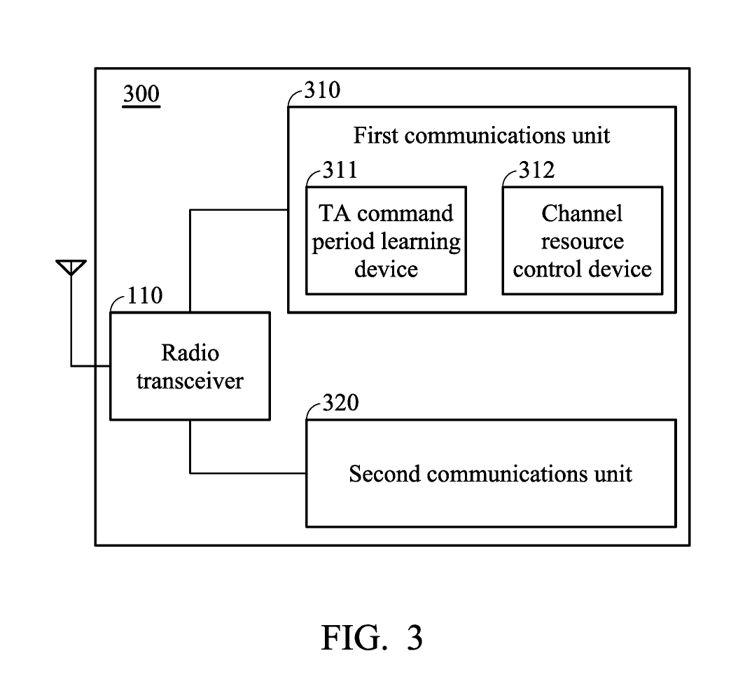

According to an embodiment of the invention, the modem 120B, the radio transceiver 110 and/or the antenna module may be shared by subscriber identity cards 140 and 160 to support at least two RATs communications. Therefore, in this embodiment, the communications apparatus 100B may be regarded as comprising at least two communications units, as per the schematic diagram shown in FIG. 3. Note that in the embodiments of single-card multi-standby application, the communications apparatus 100A may also be regarded as comprising at least two communications units as shown in FIG. 3.

According to an embodiment of the invention, the modem 120A/120B may have the capability of handling the operations of multiple cellular system communications protocols and processing the IF or baseband signals for the corresponding communications units. Each communications unit may operate independently at the same time in compliance with a corresponding communications protocol, and thereby the communications apparatus 100A/100B can support a multi-standby application.

Note that, in order to clarify the concept of the invention, FIG. 1A and FIG. 1B present simplified block diagrams in which only the elements relevant to the invention are shown. For example, in some embodiments of the invention, the communications apparatus may further comprise some peripheral devices not shown in FIG. 1A and FIG. 1B. In another example, in some embodiments of the invention, the communications apparatus may further comprise a central controller coupled to the modem 120A/120B and the application processor 130. Therefore, the invention should not be limited to what is shown in FIG. 1A and FIG. 1B.

Note further that subscriber identity cards 140 and/or 160 may be dedicated hardware cards or virtual cards as described above, or in some embodiments of the invention, there may be individual identifiers, numbers, addresses, or the like which are burned in the internal memory device of the corresponding modem and are capable of identifying the individual communications entity that the corresponding communications unit operates. Therefore, the invention should not be limited to what is shown in the figures.

Note further that, although in the embodiments discussed in the specification, the communications apparatuses support two RAT wireless communications services, the invention should not be limited thereto. Those who are skilled in this technology can still make various alterations and modifications based on the descriptions given above to derive the communications apparatuses capable of supporting more than two RAT wireless communications without departing from the scope and spirit of this invention.

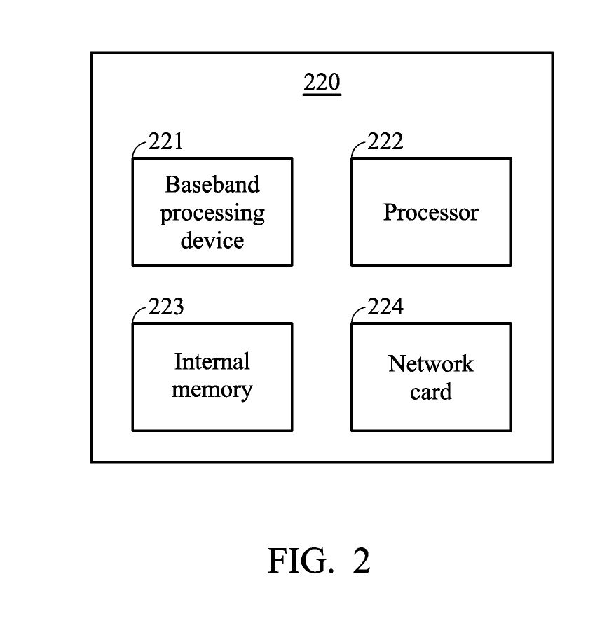

FIG. 2 shows an exemplary block diagram of a modem according to an embodiment of the invention. The modem 220 may be the modem 120A or 120B shown in FIG. 1A and FIG. 1B and may comprise at least a baseband processing device 221, a processor 222, an internal memory 223 and a network card 224. The baseband processing device 221 may receive the IF or baseband signals from the radio transceiver 110 and perform IF or baseband signal processing. For example, the baseband processing device 221 may convert the IF or baseband signals to a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, a encoder for signal encoding, a decoder for signal decoding, and so on.

The processor 222 may control the operations of the modem 220. According to an embodiment of the invention, the processor 222 may be arranged to execute the program codes of the corresponding software module of the modem 220. The processor 222 may maintain and execute the individual tasks, threads, and/or protocol stacks for different software modules. In a preferred embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may also read data from the subscriber identity card coupled to the modem, such as the subscriber identity card 140 and/or 160, and write data to the subscriber identity card. The internal memory 223 may store system data and user data for the modem 220. The processor 222 may also access the internal memory 223.

The network card 224 provides Internet access services for the communications apparatus. Note that although the network card 224 shown in FIG. 2 is configured inside of the modem, the invention should not be limited thereto. In some embodiments of the invention, the communications apparatus may also comprise a network card configured outside of the modem, or the communications apparatus may also be coupled to an external network card for providing Internet access services. Therefore, the invention should not be limited to any specific implementation method.

Note further that, in order to clarify the concept of the invention, FIG. 2 presents simplified block diagrams in which only the elements relevant to the invention are shown. Therefore, the invention should not be limited to what is shown in FIG. 2.

Note further that in some embodiments of the invention, the modem may comprise more than one processor and/or more than one baseband processing device. For example, the modem may comprise multiple processors and/or multiple baseband processing devices for supporting multi-RAT operations. Therefore, the invention should not be limited to what is shown in FIG. 2.

FIG. 3 shows an exemplary block diagram of a communications apparatus according to an embodiment of the invention. The communications apparatus 300 may comprise an antenna module comprising at least one antenna, a radio transceiver 110, a first communications unit 310 and a second communications unit 320. The first communications unit 310 may at least comprise a subscriber identity card, which may be a dedicated hardware card or a virtual card, and (all or part of) the modem and (all or part of) the application processor as shown in FIG. 1A/FIG. 1B. The second communications unit 320 may at least comprise a subscriber identity card, which may be a dedicated hardware card or a virtual card, and (all or part of) the modem and (all or part of) the application processor as shown in FIG. 1A/FIG. 1B.

The radio transceiver 110 and the antenna module are shared by the first communications unit 310 and the second communications unit 320.

According to an embodiment of the invention, the first communications unit 310 may communicate with a first wireless device in compliance with a first communications protocol via the shared radio transceiver 110 and the antenna module, and the second communications unit 320 may communicate with a second wireless device in compliance with a second communications protocol via the shared radio transceiver 110 and the antenna module. The communications apparatus 300 may support multi-standby application via the first communications unit 310, the second communications unit 320, and the shared radio transceiver 110 and the antenna module.

Note that, although in the embodiments as discussed above, the modem and the application processor are shared by multiple communications units, the invention should not be limited thereto. Those who are skilled in this technology can still make various alterations and modifications based on the descriptions given above to derive the communications apparatuses comprising multiple modems and/or multiple application processors for supporting multiple RAT wireless communications without departing from the scope and spirit of this invention.

The first wireless device may periodically or aperiodically transmit a plurality of timing advance (TA) commands, each carrying a TA value, to the first communications unit 310.

The first communications unit 310 has to receive the TA command to maintain uplink timing synchronization with the first wireless device. Upon receiving the TA command, the first communications unit 310 can derive the right time to transmit a uplink signal according to the TA value. When the first communications unit 310 transmit uplink signal at the right time, the first network device can successfully decode the uplink signal and the uplink timing between the first communications unit 310 and the first wireless device can be synchronized.

A new TA timer is activated by the first communications unit 310 every time a TA command is successfully received. The TA timer interval is defined by the standards and configured by the first network device. Before the activated TA timer expires, another TA command has to be received. If the first communications unit 310 cannot receive another TA command within the TA timer interval, the first communications unit 310 has to perform a random access procedure after the activated TA timer expires.

Generally, the period or timing of transmitting the TA command may be dynamically adjusted by the first wireless device, and the first wireless device will not notify the UE of the period or timing of transmitting the TA command. Therefore, the UE has to keep listening to the downlink signals transmitted by the first wireless device for not missing the important TA command.

However, when the radio transceiver 110 and the antenna module are shared by multiple communications units to support multi-standby application and multi-RAT communications, the first communications unit 310 will not always get the right to use the shared radio transceiver 110 and the antenna module. To avoid missing all the chances to receive the TA command within the TA timer interval and causing a random access procedure to be triggered, methods for enhancing performance of a communications apparatus are proposed and will be discussed in the following paragraphs.

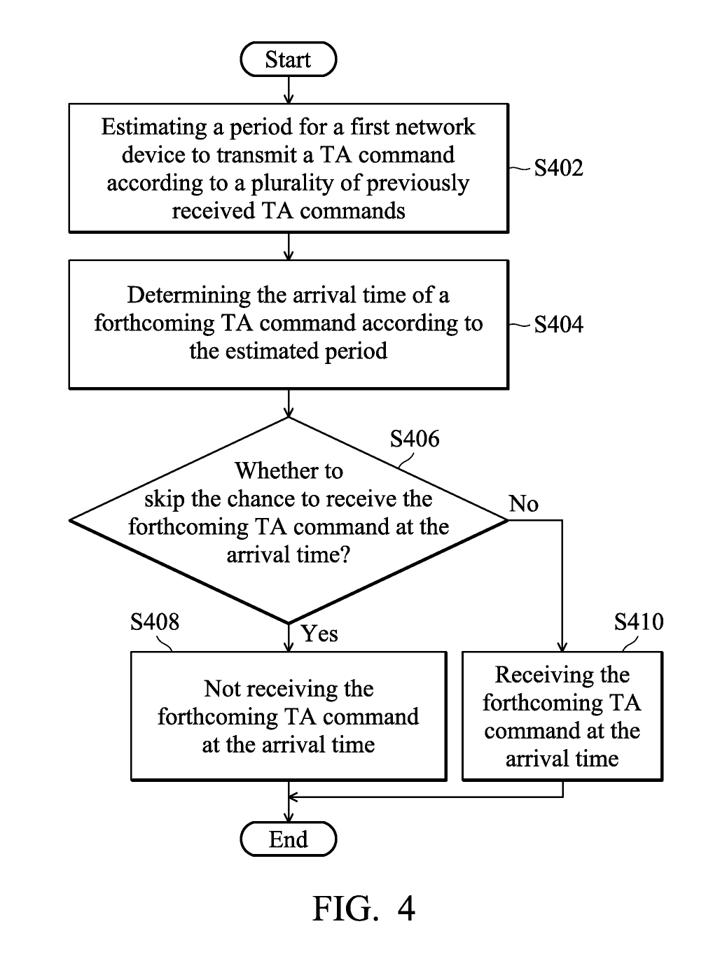

FIG. 4 is a flow chart of a method for enhancing performance of a communications apparatus according to an embodiment of the invention. First of all, a period for a first network device to transmit a TA command is estimated according to a plurality of previously received TA commands (Step S402). Next, the arrival time of a forthcoming TA command is determined according to the estimated period (Step S404). Next, whether to skip the chance to receive the forthcoming TA command at the arrival time is determined according to the estimated period and the TA timer interval (Step S406). When determining to skip the chance to receive the forthcoming TA command, the forthcoming TA command is not received by the first communications unit (Step S408). When determining not to skip the chance to receive the forthcoming TA command, the forthcoming TA command is received by the first communications unit at the arrival time (Step S410).

According to an embodiment of the invention, besides the devices as discussed above, the first communications unit 310 may further comprise a TA command period learning device 311 and a channel resource control device 312. The TA command period learning device 311 and the channel resource control device 312 may be implemented by dedicated hardware devices or software modules which are executed by the processor (e.g. the processor 222 in the modem 220) of the communications apparatus. The TA command period learning device 311 may learn the period for the first network device to transmit the TA commands according to a plurality of previously received TA commands. The channel resource control device 312 may determine a condition of a downlink channel of the first network device. The downlink channel condition may be utilized in step S406 to determine whether to skip the chance to receive the forthcoming TA command at the arrival time, which will be further discussed in the following paragraphs.

According to an embodiment of the invention, the TA command period learning device 311 (or, the processor of the communications apparatus) may record the time span between each two successively received TA commands. Suppose that the time spans between each two of (n+1) previously received TA commands are respectively represented by T1-Tn, the TA command period learning device 311 (or, the processor) may determine the TA command period as the greatest common divisor of T1-Tn, an average or a mean of T1-Tn, a median of T1-Tn, a majority of T1-Tn, or others. The TA command period learning device 311 (or, the processor) may also calculate a variance of T1-Tn, and determine the TA command period further according to the variance.

When the TA command period is determined, the processor may determine the arrival time of a forthcoming TA command according to the estimated period. For example, suppose that the time to receive the latest TA command is T, the estimated period is N, and a variance of recorded time spans is d, the possible arrival time of a forthcoming TA command may fall within a period of [T+(N−d)]˜[T+(N+d)]. In an embodiment of the invention, the processor may directly set the interval from [T+(N−d)] to [T+(N+d)] as the arrival time.

According to an embodiment of the invention, when the arrival time of a forthcoming TA command coincides with the time for the second communications unit to perform its radio activity, for example, receiving a paging message or listening to a control channel, the processor may further determine whether to skip the chance to receive the forthcoming TA command at the arrival time, and yield the right to use the radio transceiver 110 and the antenna module for the second communications unit to perform its radio activity.

According to an embodiment of the invention, the processor may determine whether to skip the chance to receive the forthcoming TA command at the arrival time according to the estimated period and the TA timer interval. In an example, when the processor notices that even if the chance to receive the forthcoming TA command at the arrival time is skipped, there is still one or more than one chance to receive other forthcoming TA command(s) before the activated TA timer expires, the processor may determine to skip the chance to receive the forthcoming TA command at the arrival time. To be more specific, the processor may determine to skip the chance to receive the forthcoming TA command at the arrival time when there is more than a predetermined number of chances to receive another forthcoming TA command before the activated TA timer expires.

On the other hand, the processor may determine not to skip the chance to receive the forthcoming TA command at the arrival time when noticing that there will be none or only a few chances to receive other forthcoming TA commands before the activated TA timer expires. To be more specific, the processor may determine not to skip the chance to receive the forthcoming TA command at the arrival time when there is no more than a predetermined number of chances to receive other forthcoming TA commands before the activated TA timer expires.

According to another embodiment of the invention, the processor may determine whether to skip the chance to receive the forthcoming TA command at the arrival time further according to a condition of a downlink channel of the first network device and/or a moving speed of the communications apparatus. To be more specific, in an embodiment of the invention, the processor may estimate a possibility to successfully receive the forthcoming TA command according to the estimated period, the TA timer interval, the condition of the downlink channel of the first network device and/or the moving speed of the communications apparatus, and determine whether to skip the chance to receive the forthcoming TA command at the arrival time according to estimated possibility.

The condition of the downlink channel may be selected from a group comprising one or a combination of a bit error rate, a block error rate, an average HARQ re-transmission count and a maximum HARQ re-transmission count of the downlink channel. The channel resource control device 312 may determine the condition of the downlink channel according to the downlink signals previously received from the first network device. The channel resource control device 312 may also estimate the moving speed of the communications apparatus according to the downlink signals previously received from the first network device.

According to an embodiment of the invention, a function F(.) to estimate the possibility of successfully receiving the forthcoming TA command may be predefined. For example, the factors to build up the function F(.) may comprise:

A: a bit error rate of the downlink channel of the first network device;

B: a block error rate of the downlink channel of the first network device;

C: an average HARQ re-transmission count of the downlink channel of the first network device;

D: a maximum HARQ re-transmission count of the downlink channel of the first network device;

E: the estimated period for the first network device to transmit the TA commands;

F: the TA timer interval; and

G: the moving speed of the communications apparatus.

For example, the function may be defined as F(A, E, F), F(A, C, E, F, G), or others.

When the possibility estimated based on the predefined function F(.) is lower than a predetermined threshold, the processor may determine not to skip the chance to receive the forthcoming TA command at the arrival time, and direct the first communications unit 310 to use the radio transceiver 110 at the arrival time of the forthcoming TA command to receive the forthcoming TA command.

When the possibility estimated based on the predefined function F(.) is not lower than a predetermined threshold, the processor may determine to skip the chance to receive the forthcoming TA command at the arrival time, direct the first communications unit 310 not to use the radio transceiver 110 at the arrival time of the forthcoming TA command and direct the second communications unit 320 to use the radio transceiver 110 at the arrival time of the forthcoming TA command to perform one or more corresponding radio activities. That is, the first communications unit 310 is not allowed to use the radio transceiver 110 at the arrival time, and the second communications unit 320 is allowed to use the radio transceiver 110 at the arrival time.

Take a predefined function F(B, E, F) as an example. Suppose that the block error rate is x, the time to receive the latest TA command is T, the estimated period is N, the TA timer interval is M, and the variance of the recorded time spans is 0, the possible arrival time of the next TA command is (T+N), and there will be (M/N) (or, a divisor of (M/N) when M cannot be fully divided by N) (hereinafter use (M/N) for simplicity) chances to receive a TA command before the activated TA timer expires, and the probability of successfully receiving the TA command is (1−x). The function F(B, E, F) may be defined as F=(1−x)*(M/N), and the predetermined threshold may be set to TH. If (1−x)*(M/N)>=TH, the processor may determine to skip the chance to receive the next TA command at the estimated arrival time. If (1−x)*(M/N)<TH, the processor may determine not to skip the chance to receive the next TA command at the estimated arrival time.

According to an embodiment of the invention, the TA command period learning device 311 or the processor may learn the period for the first network device to transmit the TA commands, again, when a handover has occurred, detecting that the TA command period has been changed, or when the TA timer expires. In the embodiments of the invention, the processor may keep monitoring the TA command period according to the received TA commands. For example, the TA command period changes when the camped-on cell of the communications apparatus changes. For another example, the first network device may change the TA command period when detecting that a moving speed of the communications apparatus changes.

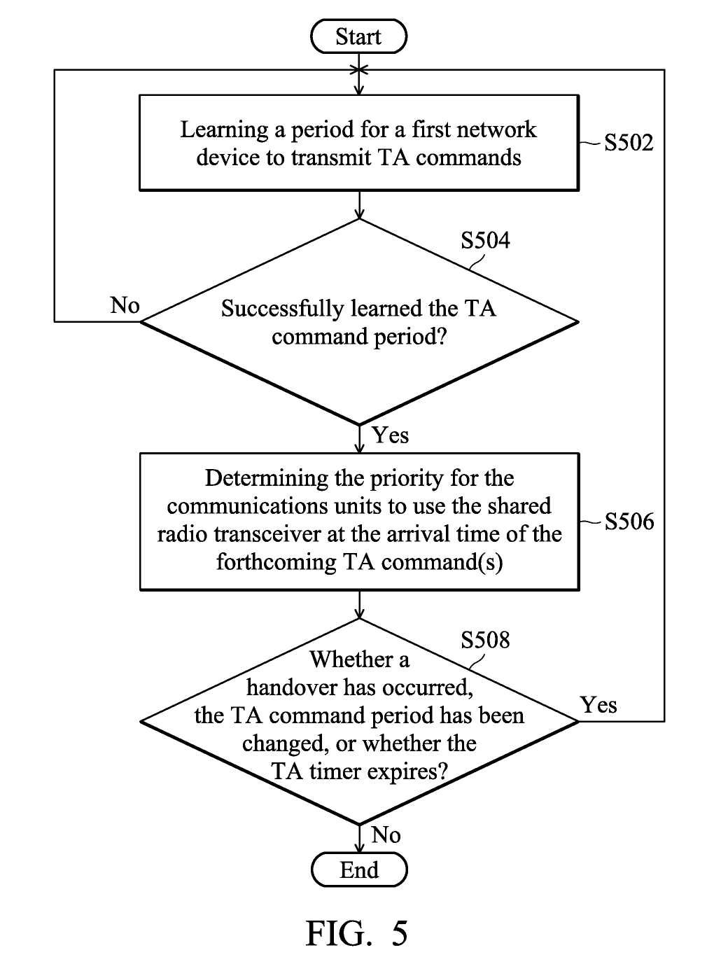

FIG. 5 is a flow chart of a method for enhancing performance of a communications apparatus according to another embodiment of the invention. First of all, the TA command period learning device 311 or the processor may keep learning a period for a first network device to transmit TA commands (Step S502) until determining that the TA command period learning device 311 or the processor has successfully learned the TA command period (Step S504). Next, the processor may determine which communications unit can use the radio transceiver or determine the priority for the communications units to use the shared radio transceiver at the arrival time of the forthcoming TA commands (Step S506) as detailed in the determination methods discussed above. Next, the processor may determine whether a handover has occurred, whether the TA command period has been changed, or whether the TA timer has expired (Step S508). When a handover has occurred, the TA command period has been changed, or the TA timer expires, the procedure may return to step S502 for the TA command period learning device 311 or the processor to learn the TA command period, again.

According to another embodiment of the invention, in step S506, the processor may also determine to receive K TA commands within the TA timer interval. Suppose that the estimated period is N and the TA timer interval is M, the processor may derive that the first network device may transmit (M/N) TA commands within the TA timer interval. Then, the processor may select K chances to receive a TA command within the TA timer interval, where K is a positive integer and K<=(M/N).

According to an embodiment of the invention, the processor may determine the value of K according to the average HARQ re-transmission count of the downlink channel of the first network device, the maximum HARQ re-transmission count of the downlink channel of the first network device, an expectation value of x/((1−x)̂2), where x is the block error rate of the downlink channel of the first network device, the possibility to successfully receive the forthcoming TA command which can be higher than the predetermined threshold after receiving K TA commands, or others.

When the value of K is determined, the processor may further determine the distribution of the K chance(s) to receive the TA command. According to an embodiment of the invention, the processor may evenly distribute the K chances to receive the TA command within the TA timer interval. According to another embodiment of the invention, the processor may arrange the K chances to receive a TA command at the end of the TA timer interval. That is, arrange the K chances to receive a TA command as the last K changes to receive the TA command within the TA timer interval, so as activate another TA timer as late as possible. According to yet another embodiment of the invention, the processor may randomly arrange the K chances to receive a TA command within the TA timer interval. According to yet another embodiment of the invention, the processor may arrange the K chances to receive a TA command at a time at which the second or another communications unit does not need to use the radio transceiver.

Based on the methods as discussed above, the situation of missing all the chances to receive the TA command within the TA timer interval and causing a random access procedure to be triggered can be avoided when the radio transceiver 110 and the antenna module are shared by multiple communications units to support multi-standby application and multi-RAT communications. Therefore, performance of the communications apparatus can be enhanced.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus, comprising:
a radio transceiver, transmitting or receiving wireless radio frequency signals to communicate with a first network device; and
a processor, estimating a period for the first network device to transmit a timing advance (TA) command according to a plurality of previously received TA commands, determining an arrival time of a forthcoming TA command according to the estimated period, determining whether to skip a chance to receive the forthcoming TA command at the arrival time according to the estimated period and a TA timer interval, and not using the radio transceiver to receive the forthcoming TA command at the arrival time when determining to skip the chance.

2. The communications apparatus as claimed in claim 1, further comprising:
a first communications unit, communicating with the first wireless device in compliance with a first communications protocol; and
a second communications unit, communicating with a second wireless device in compliance with a second communications protocol,
wherein the first communications unit and the second communications unit share the radio transceiver, and wherein when the processor determines to skip the chance for the first communications unit to receive the forthcoming TA command at the arrival time, the first communications unit is not allowed to use the radio transceiver at the arrival time of the forthcoming TA command and the second communications unit is allowed to use the radio transceiver at the arrival time of the forthcoming TA command to perform one or more corresponding radio activities.

3. The communications apparatus as claimed in claim 1, wherein the processor determines whether to skip the chance to receive the forthcoming TA command at the arrival time further according to a condition of a downlink channel of the first network device and/or a moving speed of the communications apparatus.

4. The communications apparatus as claimed in claim 3, wherein the condition is selected from a group comprising one or a combination of a bit error rate, a block error rate, an average HARQ re-transmission count and a maximum HARQ re-transmission count of the downlink channel.

5. The communications apparatus as claimed in claim 3, wherein the processor further estimates a possibility to successfully receive the forthcoming TA command according to the estimated period, the TA timer interval, the condition of the downlink channel of the first network device and/or the moving speed of the communications apparatus, and determines whether to skip the chance to receive the forthcoming TA command at the arrival time according to the estimated possibility.

6. The communications apparatus as claimed in claim 5, wherein when the possibility is lower than a predetermined threshold, the processor determines not to skip the chance to receive the forthcoming TA command at the arrival time.

7. The communications apparatus as claimed in claim 5, wherein when the possibility is not lower than a predetermined threshold, the processor determines to skip the chance to receive the forthcoming TA command at the arrival time.

8. A method for enhancing performance of a communications apparatus, comprising:
estimating a period for a first network device to transmit a timing advance (TA) command according to a plurality of previously received TA commands;
determining an arrival time of a forthcoming TA command according to the estimated period;
determining whether to skip a chance to receive the forthcoming TA command at the arrival time according to the estimated period and a TA timer interval; and
not receiving the forthcoming TA command at the arrival time when determining to skip the chance to receive the forthcoming TA command.

9. The method as claimed in claim 8, wherein the communications apparatus comprises a first communications unit communicating with the first wireless device in compliance with a first communications protocol, a second communications unit communicating with a second wireless device in compliance with a second communications protocol and a radio transceiver shared by the first communications unit and the second communications unit, and when determining to skip the chance for the first communications unit to receive the forthcoming TA command, the method further comprises:
directing the first communications unit not to use the radio transceiver at the arrival time of the forthcoming TA command; and
directing the second communications unit to use the radio transceiver at the arrival time of the forthcoming TA command to perform one or more corresponding radio activities.

10. The method as claimed in claim 8, wherein whether to skip a chance to receive the forthcoming TA command at the arrival time is determined further according to a condition of a downlink channel of the first network device and/or a moving speed of the communications apparatus.

11. The method as claimed in claim 10, wherein the condition is selected from a group comprising one or a combination of a bit error rate, a block error rate, an average HARQ re-transmission count and a maximum HARQ re-transmission count of the downlink channel.

12. The method as claimed in claim 10, wherein the step of determining whether to skip a chance to receive the forthcoming TA command at the arrival time further comprises:
estimating a possibility to successfully receive the forthcoming TA command according to the estimated period, the TA timer interval, the condition of the downlink channel of the first network device and/or the moving speed of the communications apparatus; and
determining whether to skip the chance to receive the forthcoming TA command at the arrival time according to the estimated possibility.

13. The method as claimed in claim 12, further comprising:
determining not to skip the chance to receive the forthcoming TA command at the arrival time when the possibility is lower than a predetermined threshold.

14. The method as claimed in claim 12, further comprising:
determining to skip the chance to receive the forthcoming TA command at the arrival time when the possibility is not lower than a predetermined threshold.
